(19) United States
(12) Patent Application Publication
(10) Pub. No.: US 2015/0345767 A1
(43) Pub. Date: Dec. 3, 2015

(54) OPTICAL SEMICONDUCTOR ILLUMINATING APPARATUS

(71) Applicant: Posco LED Company Ltd., Yongin-si (KR)

(72) Inventors: Su Woon LEE, Yongin-si (KR); Sang Hyuk KIM, Yongin-si (KR); Yoon Gil JANG, Yongin-si (KR); Seok Jin KANG, Yongin-si (KR); Dae Won KIM, Yongin-si (KR); Jung Hwa KIM, Yongin-si (KR)

(21) Appl. No.: 14/717,184

(22) Filed: May 20, 2015

(30) Foreign Application Priority Data
May 29, 2014 (KR) 10-2014-0065364

(51) Int. Cl. F21V 23/06; F21V 29/70; F21V 19/00; F21V 15/01

(52) U.S. Cl. CPC F21V 23/06; F21V 15/01; F21V 29/70; F21V 19/0015; F21Y 2101/02

(57) ABSTRACT

An optical semiconductor illuminating apparatus includes a housing configured to receive power from one side thereof and comprising a first area, a heat dissipation base extending from the housing and comprising a second area smaller than the first area, and a light emitting module comprising at least one optical semiconductor device disposed on a portion of the housing and the heat dissipation base, and comprising a third area smaller than the first area and larger than the second area, in which the housing forms an overlap region comprising a fourth area overlapping the light emitting module, and the light emitting module is electrically connected to a power source through the overlap region.

### CROSS-REFERENCE TO RELATED APPLICATION

This application claims priority from and the benefit of Korean Patent Application No. 10-2014-0065364, filed on May 29, 2014, which is hereby incorporated by reference for all purposes as if fully set forth herein.

### BACKGROUND

1. Field

Exemplary embodiments of the present invention relate to an optical semiconductor illuminating apparatus. More particularly, to an optical semiconductor illuminating apparatus that can secure complete waterproofing and airtightness, and provide pleasant connection of interconnection lines while reducing the number of unnecessary components, such as a cable gland.

2. Description of the Background

Optical semiconductor devices such as light emitting diodes (LEDs) or laser diodes (LDs) have been broadly spotlighted as a component for illuminating apparatuses due to their various merits, such as lower power consumption, longer lifespan, better durability, and much higher brightness than incandescent lamps or fluorescent lamps.

An illuminating apparatus employing such an optical semiconductor device can be used in outdoor lighting such as street lamps or security lamps, which may be waterproof and airtight, in order to prevent current leakage due to moisture by rain or snow.

An interconnection line such as a cable is connected to a light emitting module including an optical semiconductor having a substrate, and airtight components such as a cable grand are used in order to prevent moisture infiltration into a space between the interconnection line and a power supply.

However, such airtight components suffer from deterioration in airtightness after use of the illuminating apparatus for a long period of time.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide an optical semiconductor illuminating apparatus that can secure complete waterproofing and airtightness, and provide pleasant connection of interconnection lines while reducing the number of unnecessary components such as a cable gland.

Additional aspects will be set forth in the detailed description which follows, and, in part, will be apparent from the disclosure, or may be learned by practice of the inventive concept.

According to an exemplary embodiment of the present invention, an optical semiconductor illuminating apparatus includes a housing configured to receive power from one side thereof and comprising a first area, a heat dissipation base extending from the housing and comprising a second area smaller than the first area, and a light emitting module comprising at least one optical semiconductor device disposed on a portion of the housing and the heat dissipation base, the light emitting module comprising a third area smaller than the first area and larger than the second area, in which the housing forms an overlap region comprising a fourth area overlapping the light emitting module, and the light emitting module is electrically connected to a power source through the overlap region.

The optical semiconductor illuminating apparatus may further include a depressed end step disposed on a portion of a lower surface of the housing, and a mounting plane on which the light emitting module is disposed, the mounting plane comprising a lower surface of the heat dissipation base.

The optical semiconductor illuminating apparatus may further include an interconnection line passage through which an interior of the housing is connected with the mounting plane, and the interconnection line passage is orthogonal to the mounting plane.

The optical semiconductor illuminating apparatus may further include a stepped groove extending from a lower edge of the interconnection line passage and depressed in the mounting plane, in which the interconnection line passage may be disposed on the overlap region.

The stepped groove may be disposed on the lower surface of the housing.

The stepped groove may have a rounded edge.

The optical semiconductor illuminating apparatus may further include a first port disposed inside the housing, a second port disposed on an outer surface of the overlap region, and an interconnection line passage disposed between the first port and the second port, the interconnection line passage configured to connect with the interior of the housing.

The optical semiconductor illuminating apparatus may further include an interconnection line passage disposed between a first port disposed inside the housing and a second port disposed on an outer surface of the overlap region, in which a virtual straight line interconnecting the first port and the second port may be orthogonal to the outer surface of the overlap region.

The optical semiconductor illuminating apparatus may further include an interconnection line passage disposed between a first port disposed inside the housing and a second port disposed on an outer surface of the overlap region, in which a virtual straight line interconnecting the first port and the second port may be orthogonal to the outer surface of the overlap region and pass through an interior of the housing.

The interconnection line passage may have rounded edges at opposite ends thereof.

Each of the first port and the second port may have a rounded edge.

The optical semiconductor illuminating apparatus may further include a depressed end step disposed on a portion of a lower surface of the housing, a mounting plane on which the light emitting module is disposed, the mounting plane comprising a lower surface of the heat dissipation base, and an end step protruding along an edge of the mounting plane.

As used herein, the term “optical semiconductor device” may refer to a light emitting diode chip and the like, which may include or use an optical semiconductor. Such an optical semiconductor device may include a semiconductor package in which a variety of optical semiconductors including the light emitting diode chip are disposed.

Exemplary embodiments of the present invention as described above provide the following advantageous effects.

First, the optical semiconductor illuminating apparatus according to exemplary embodiments of the present invention adopts a structure wherein the light emitting module is electrically connected to a power source through the interior of the housing, thereby securing complete waterproofing and airtightness, and providing pleasant connection of interconnection lines while reducing the number of unnecessary components such as a cable gland.

The optical semiconductor illuminating apparatus according to exemplary embodiments of the present invention includes a depressed end step formed on a portion of a lower surface of the housing and a mounting plane including a lower surface of the heat dissipation base, thereby enabling accurate detection of a mounting position of the light emitting module, while allowing easy assembly and fastening of the light emitting module.

Further, the optical semiconductor illuminating apparatus according to exemplary embodiments of the present invention includes an interconnection line passage through which the mounting plane communicates with the housing, such that an interconnection line is not exposed, thereby preventing current leakage and electric shock due to moisture infiltration while providing a pleasant outer appearance.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a sectional view illustrating overall configuration of an optical semiconductor illuminating apparatus according to one exemplary embodiment of the invention;

FIG. 2 is a partially enlarged view of Part A in FIG. 1; and

FIG. 3 is a cross-sectional view of an internal structure of the optical semiconductor illuminating apparatus viewed in direction B of FIG. 1.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

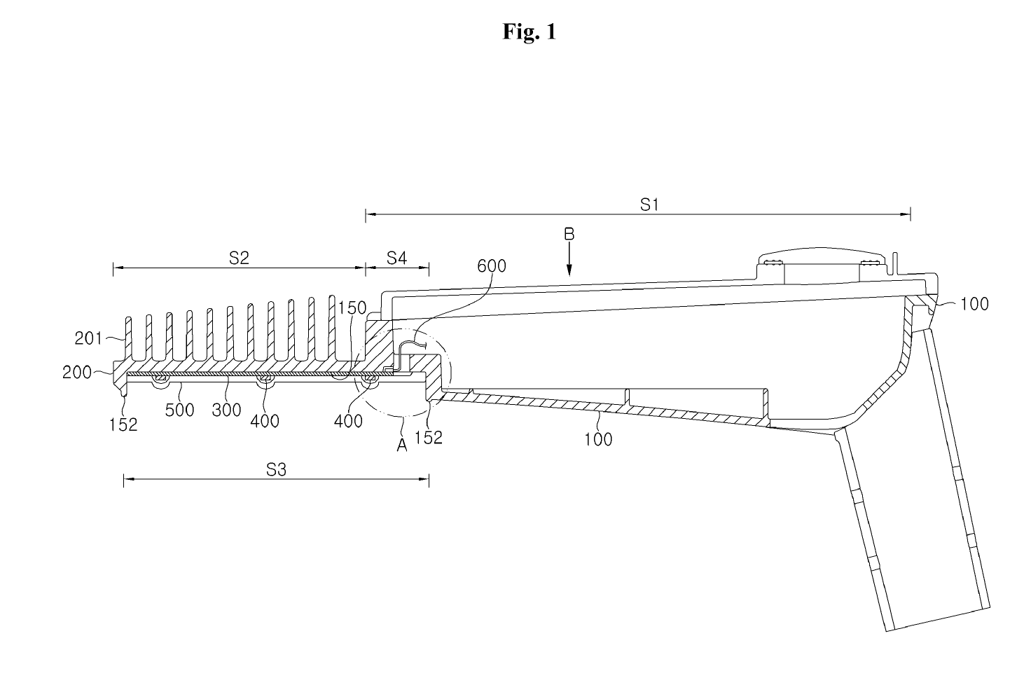

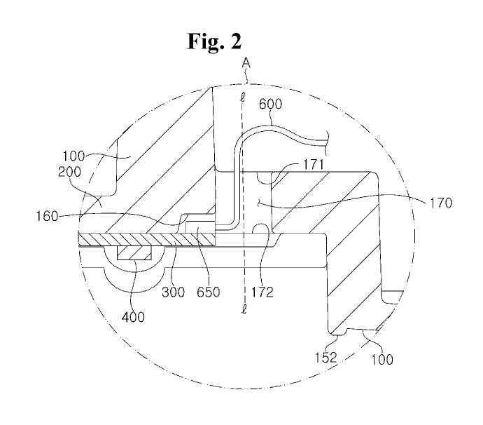

FIG. 1 is a sectional view illustrating overall configuration of an optical semiconductor illuminating apparatus according to an exemplary embodiment of the present invention, and FIG. 2 is a partially enlarged view of Part A of FIG. 1.

Referring to FIG. 1 and FIG. 2, in the optical semiconductor illuminating apparatus according to the present exemplary embodiment, a light emitting module 300 is electrically connected to a power source through a housing 100 that includes a heat dissipation base 200.

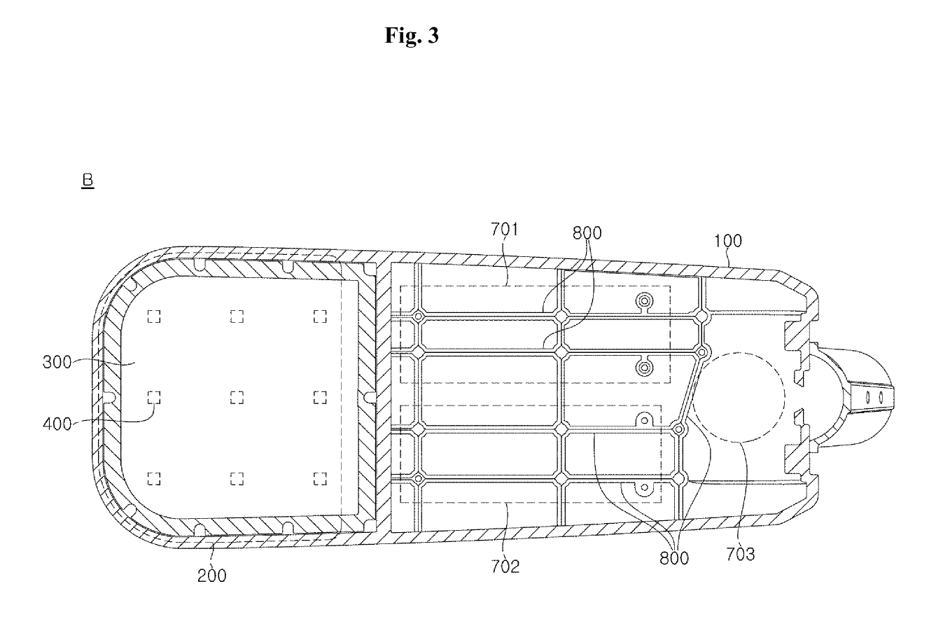

The housing 100 is configured to receive power from one side thereof. The housing has a space to include various components, such as power supply units 701 and 702 (see FIG. 3), an illuminance sensor 703 (see FIG. 3), and the like. The housing has a first area S1.

The heat dissipation base 200 extends from the housing 100 and has a second area S2 smaller than the first area S1. The heat dissipation base 200 includes a plurality of heat dissipation fins 201 to discharge heat generated from an optical semiconductor device 400 described below.

The light emitting module 300 is placed on a portion of the housing 100 and on the heat dissipation base 200, and includes at least one optical semiconductor device 400. The light emitting module has a third area S3 smaller than the first area S1 and larger than the second area S2, and the optical semiconductor device 400 acts as a light source.

The third area S3 forms an overlap region A that overlaps the first area S1 and has a fourth area S4, such that a portion of the light emitting module 300 is disposed on a lower surface of the housing 100.

Accordingly, the light emitting module 300 is electrically connected to a power source through the housing 100 and the overlap region A, thereby securing complete waterproofing and airtightness, and providing pleasant connection of interconnection lines while reducing the number of unnecessary components such as a cable gland.

In other words, in order to allow arrangement and connection of an interconnection line, such as a cable 600, inside the housing 100 without using a separate component for maintaining airtightness, such as a cable grand, the light emitting module 300 has a larger area than the heat dissipation base 200 and a portion of the light emitting module 300 is disposed on the lower surface of the housing 100.

It should be understood that the present invention can be realized not only by the embodiment described above, but also by various embodiments as follows.

More specifically, referring to FIG. 1, since an area occupied by the light emitting module 300, that is, the third area S3, is larger than an area occupied by the heat dissipation base 200, that is, the second area S2, a portion of the light emitting module 300 is disposed on a portion of the lower surface of the housing 100, that is, a portion of the first area S1, thereby enabling pleasant connection of the cable 600 through the light emitting module 300 and the overlap region A inside the housing 100.

The optical semiconductor illuminating apparatus further includes a depressed end step 152 formed on a portion of the lower surface of the housing 100 and a mounting plane 150 including a lower surface of the heat dissipation base 200, to secure pleasant connection of the cable 600. The light emitting module 300 can be placed on the mounting plane 150.

That is, the mounting plane 150 is formed to allow accurate detection of a mounting position of the light emitting module 300 while allowing easy assembly of the light emitting module 300, and the end step 152 may protrude along an edge of the mounting plane 150.

The light emitting module 300 secured to the mounting plane 150 is protected by an optical member 500, and the end step 152 is formed to prevent the optical member 500 formed of a transparent or translucent polycarbonate resin from discoloration such as yellowing, degradation, or deformation due to exposure to UV light.

According to the present exemplary embodiment, an interconnection line passage 170 is formed through the housing 100 such that the interior of the housing 100 communicates with the mounting plane 150 therethrough. The interconnection line passage 170 is orthogonal to the mounting plane 150.

More specifically, the interconnection line passage 170 includes a first port 171 formed inside the housing 100 and a second port 172 formed on the mounting plane 150, in which the first port 171 and the second port 172 communicate with each other.

Here, a virtual straight line connecting the first port 171 to the second port 172 is orthogonal to the mounting plane 150.

Since the virtual straight line passes through the interior of the housing 100, the cable 600 can be directly connected to the light emitting module 300 inside the housing 100.

Further, edges of the interconnection line passage 170, that is, edges of the first port 171 and the second port 172, are preferably rounded to protect a coating of the cable 600.

According to an exemplary embodiment of the present invention, the interconnection line passage may be coated with a paint having lower friction resistance than the coating of the cable 600, or members having lower friction resistance than the coating of the cable 600 may be mounted on the first and second ports 171 and 172. As such, the interconnection line passage 170 may have various applications and designs.

Referring to FIG. 2, according to an exemplary embodiment of the present invention, the optical semiconductor illuminating apparatus may further include a stepped groove 160 extending from a lower edge of the interconnection line passage 170 and depressed in the mounting plane 150.

Here, the stepped groove 160 may provide a space in which a connector 650 or a portion of the cable 600 can be placed such that the connector 650 placed on the lower surface of the housing 100 can be connected to the power supply units 701 and 702 of the housing 100 through the cable 600.

The stepped groove 160 may have a round edge to protect the coating of the cable 600. Here, the stepped groove may have various applications and designs. According to an exemplary embodiment of the present invention, a protective member for protection of the interconnection line may be placed on the entirety of the stepped groove 160.

Referring to FIG. 3, the optical semiconductor illuminating apparatus may further include a support rib 800 formed on an inner bottom surface of the housing 100 in order to allow the power supply units having various sizes such as a first SMPS 701 and a second SMPS 702 to be selectively mounted, depending on an area where the illuminating apparatus is disposed, using various structures inside the housing 100.

According to exemplary embodiments of the present invention, an optical semiconductor illuminating apparatus that can secure complete waterproofing and airtightness, and provide pleasant connection of interconnection lines while reducing the number of unnecessary components such as a cable gland.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. An optical semiconductor illuminating apparatus, comprising:
a housing configured to receive power from one side thereof and comprising a first area;
a heat dissipation base extending from the housing and comprising a second area smaller than the first area; and
a light emitting module comprising at least one optical semiconductor device disposed on a portion of the housing and the heat dissipation base, the light emitting module comprising a third area smaller than the first area and larger than the second area,
wherein the housing comprises an overlap region comprising a fourth area overlapping the light emitting module, and the light emitting module is electrically connected to a power source through the overlap region.

2. The optical semiconductor illuminating apparatus of claim 1, further comprising:
a depressed end step disposed on a portion of a lower surface of the housing; and
a mounting plane on which the light emitting module is disposed, the mounting plane comprising a lower surface of the heat dissipation base.

3. The optical semiconductor illuminating apparatus of claim 1, further comprising:
an interconnection line passage through which an interior of the housing is connected with the mounting plane, the interconnection line passage being orthogonal to the mounting plane.

4. The optical semiconductor illuminating apparatus of claim 3, further comprising:
a stepped groove extending from a lower edge of the interconnection line passage and depressed in the mounting plane,
wherein the interconnection line passage is disposed on the overlap region.

5. The optical semiconductor illuminating apparatus of claim 4, wherein the stepped groove is disposed on a lower surface of the housing.

6. The optical semiconductor illuminating apparatus of claim 4, wherein the stepped groove has a rounded edge.

7. The optical semiconductor illuminating apparatus of claim 1, further comprising:
a first port disposed inside the housing;
a second port disposed on an outer surface of the overlap region; and
an interconnection line passage disposed between the first port and the second port, the interconnection line passage configured to connect with an interior of the housing.

8. The optical semiconductor illuminating apparatus of claim 1, further comprising:
an interconnection line passage disposed between a first port disposed inside the housing and a second port disposed on an outer surface of the overlap region,
wherein a virtual straight line interconnecting the first port and the second port is orthogonal to the outer surface of the overlap region.

9. The optical semiconductor illuminating apparatus of claim 1, further comprising:
an interconnection line passage disposed between a first port disposed inside the housing and a second port disposed on an outer surface of the overlap region,
wherein a virtual straight line interconnecting the first port and the second port is orthogonal to the outer surface of the overlap region and passes through an interior of the housing.

10. The optical semiconductor illuminating apparatus of claim 3, wherein the interconnection line passage has rounded edges at opposite ends thereof.

11. The optical semiconductor illuminating apparatus of claim 4, wherein the interconnection line passage has rounded edges at opposite ends thereof.

12. The optical semiconductor illuminating apparatus of claim 7, wherein each of the first port and the second port has a rounded edge.

13. The optical semiconductor illuminating apparatus of claim 8, wherein each of the first port and the second port has a rounded edge.

14. The optical semiconductor illuminating apparatus of claim 9, wherein each of the first port and the second port has a rounded edge.

15. The optical semiconductor illuminating apparatus of claim 1, further comprising:
a depressed end step disposed on a portion of the lower surface of the housing;
a mounting plane on which the light emitting module is disposed, the mounting plane comprising a lower surface of the heat dissipation base; and
an end step protruding along an edge of the mounting plane.
